(19) United States
(12) Patent Application Publication
(10) Pub. No.: US 2025/0062439 A1
(43) Pub. Date: Feb. 20, 2025

(54) BATTERY PACK THERMAL EXCHANGE PLATE CONNECTOR

(71) Applicant: Ford Global Technologies, LLC, Dearborn, MI (US)

(72) Inventors: Eid Farha, Ypsilanti, MI (US); Steve Droste, Canton, MI (US); Samir Subba, Dearborn, MI (US)

(21) Appl. No.: 18/451,353

(22) Filed: Aug. 17, 2023

(51) Int. Cl. H01M 10/6556; F16B 5/06; H01M 10/613; H01M 10/6554; H01M 50/204; H01M 50/262

(52) U.S. Cl. CPC H01M 10/6556; F16B 5/0621; H01M 10/613; H01M 10/6554; H01M 50/204; H01M 50/262; H01M 2220/20

(57) ABSTRACT

An traction battery pack assembly includes a first plate and a second plate secured adjacent to the first plate to provide at least one coolant passage that extends through an interior area of a battery pack enclosure. The at least one coolant passage is between the first plate and the second plate. A connector is fluidly coupled to the at least one coolant passage. The connector is removably connectable with a conduit at a position outside the battery pack enclosure.

### TECHNICAL FIELD

This disclosure relates generally to a connections for a thermal exchange plate used in a traction battery pack.

### BACKGROUND

A traction battery pack of an electrified vehicle can include groups of battery cells arranged in one or more cell stacks. A thermal exchange plates can be incorporated into the traction battery pack. A fluid, such as a liquid coolant, can be circulated though the thermal exchange plate to help manage thermal energy.

### SUMMARY

In some aspects, the techniques described herein relate to an assembly, including: a first plate; a second plate secured adjacent to the first plate to provide at least one coolant passage that extends through an interior area of a battery pack enclosure, the at least one coolant passage is between the first plate and the second plate; and a connector fluidly coupled to the at least one coolant passage, the connector removably connectable with a conduit at a position outside the battery pack enclosure.

In some aspects, the techniques described herein relate to an assembly, wherein the connector is a quick-connect connector.

In some aspects, the techniques described herein relate to an assembly, wherein the connector is adhesively secured directly to the second plate.

In some aspects, the techniques described herein relate to an assembly, wherein the connector extends through an opening in the battery pack enclosure.

In some aspects, the techniques described herein relate to an assembly, wherein the connector extends through a plate opening of the second plate.

In some aspects, the techniques described herein relate to an assembly, wherein the second plate provides an entire circumferential periphery of the plate opening.

In some aspects, the techniques described herein relate to an assembly, wherein the first plate provides no portion of the plate opening.

In some aspects, the techniques described herein relate to an assembly, wherein the connector is secured directly to a bumped-out area of the second plate, the bumped-out area extending through an opening in the battery pack enclosure.

In some aspects, the techniques described herein relate to an assembly, wherein the opening is provided within a wall of an enclosure tray, the bumped-out area extending from inside the battery pack enclosure though the opening to a position outside the battery pack enclosure.

In some aspects, the techniques described herein relate to an assembly, wherein the connector is a first connector, and further including a second connector, the first connector providing a coolant inlet to the at least one coolant passage, the second connector providing a coolant outlet from the at least one coolant passage.

In some aspects, the techniques described herein relate to an assembly, wherein no portion of the connector is sandwiched between both the first plate and the second plate.

In some aspects, the techniques described herein relate to an assembly, wherein the first plate and the second plate each include an upturned flange, the connector secured directly to the upturned flange of the second plate to fluidly couple the connector to the at least one coolant passage.

In some aspects, the techniques described herein relate to an assembly, further including a seal sandwiched by the upturned flange of the second plate and the battery pack enclosure.

In some aspects, the techniques described herein relate to an assembly, further including a plurality of mechanical fasteners extending through the battery pack enclosure to engage the first plate and the second plate.

In some aspects, the techniques described herein relate to an assembly, wherein the connector is secured directly to a bumped-out area of the second plate.

In some aspects, the techniques described herein relate to an assembly, wherein the at least one coolant passage includes a serpentine coolant passage configured to communicate a thermal exchange fluid.

In some aspects, the techniques described herein relate to a battery assembly, including: a plurality of battery cells; an enclosure assembly that houses said plurality of battery cells; a thermal exchange plate assembly in thermal communication with the plurality of battery cells, wherein a bumped-out area of the thermal exchange plate assembly protrudes through the enclosure assembly; and a connector disposed on the bumped-out area.

In some aspects, the techniques described herein relate to a battery assembly, wherein the connector is a quick-connect.

In some aspects, the techniques described herein relate to a battery assembly, wherein said thermal exchange plate assembly is part of a thermal management system of a traction battery pack.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 1 along with a thermal exchange device of the electrified vehicle

FIG. 3 illustrates an overhead, perspective view of a tray and a thermal exchange plate assembly from the battery pack of FIG. 2.

FIG. 4 illustrates a front view the tray and thermal exchange plate assembly of FIG. 3.

FIG. 5 illustrates a section view taken at line 5-5 in FIG. 4.

FIG. 6 illustrates a perspective view of a connection interface portion of the thermal exchange plate from the battery pack of FIG. 2.

### DETAILED DESCRIPTION

This disclosure details exemplary thermal exchange plate assemblies for a traction battery pack. Thermal exchange plates of these assemblies can fluidly connect to a connector, such as a quick-connect connector, that can be removably connected to a conduit that delivers coolant to the thermal exchange plate or a conduit that takes coolant from the thermal exchange plate. The removable connection can reduce complexity and reduce a required packaging footprint.

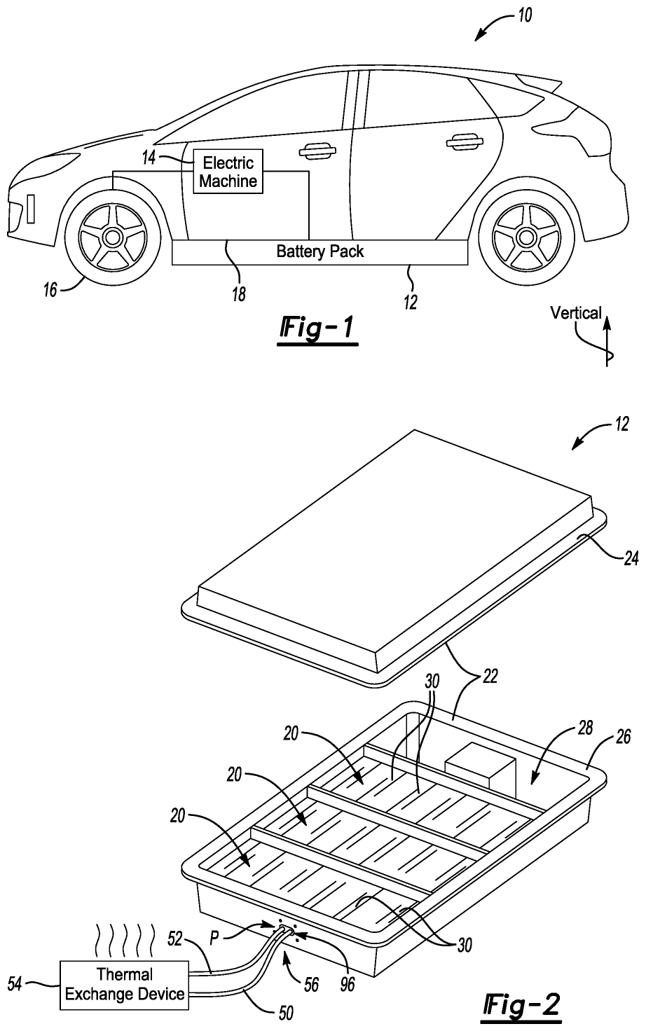

With reference to FIG. 1, an electrified vehicle 10 includes a battery pack 12, an electric machine 14, and wheels 16. The battery pack 12 powers the electric machine 14, which can convert electrical power to mechanical power to drive the wheels 16.

The battery pack 12 is, in the exemplary embodiment, secured to an underbody 18 of the electrified vehicle 10. The battery pack 12 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

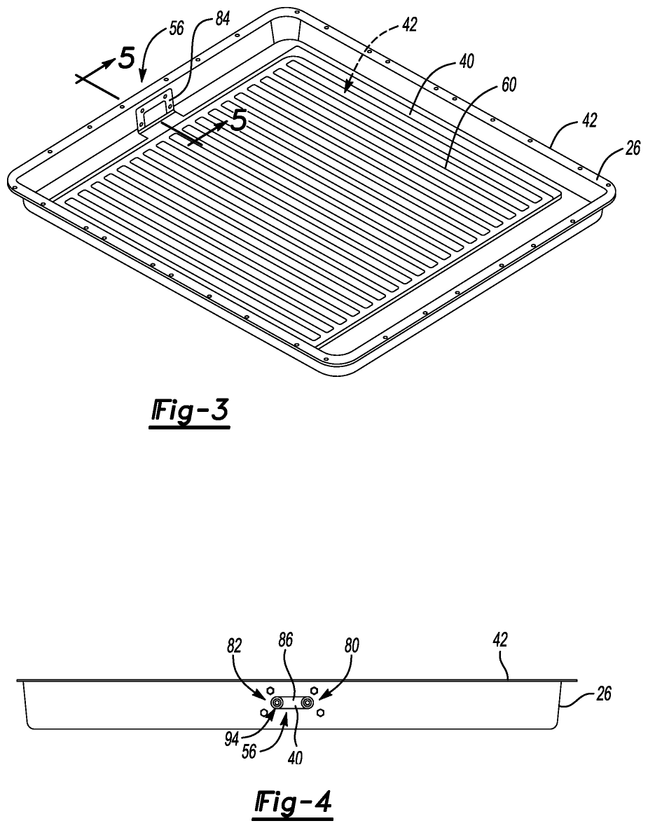

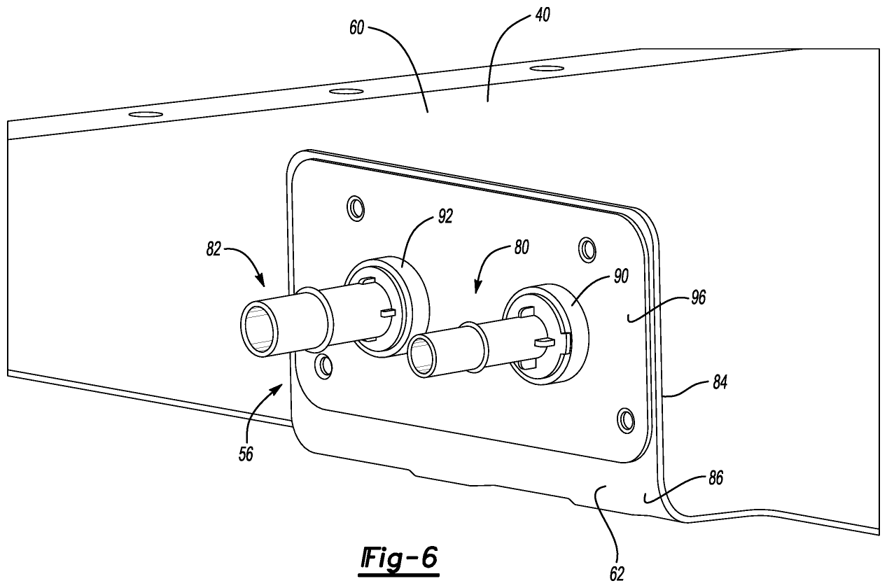

With reference now to FIGS. 2-6, the battery pack 12 includes a plurality of cell stacks 20 held within a battery pack enclosure 22. In the exemplary embodiment, the enclosure 34 includes an enclosure cover 24 and an enclosure tray 26. The enclosure cover 24 is secured to the enclosure tray 26 to provide an interior area 28 that houses the cell stacks 20. The enclosure cover 24 can be secured to the enclosure tray 26 using mechanical fasteners (not shown), for example.

Each of the cell stacks 20 includes a plurality of battery cells 30 disposed along a respective cell stack axis. Within each cell stack 20, the battery cells 30 are stacked side-by-side relative to each other along the cell stack axis. The battery cells 30 store and supply electrical power. Although specific numbers of the cell stacks 20 and cells 30 are illustrated in the various figures of this disclosure, the battery pack 12 could include any number of the cell stacks 20 having any number of individual cells 30.

In an embodiment, the battery cells 30 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

The battery cells 30 are disposed upon a thermal exchange plate assembly 40, which includes at least one coolant passage 42. The thermal exchange plate assembly 40 is part of a thermal management system for the battery pack 12.

Coolant, such as a liquid coolant, can be circulated through the at least one coolant passage 42. The at least one coolant passage can be a serpentine coolant passage configured to communicate a thermal exchange fluid.

In this example, coolant is moved to the battery pack 12 through an inlet conduit 50. The coolant can take on thermal energy within the battery pack 12. Coolant is then moved from the battery pack 12 through an outlet conduit 52. The coolant from the battery pack 12 can be moved to a thermal exchange device 54 such as a liquid-to-air heat exchanger. At the thermal exchange device 54, thermal energy can be released to an ambient environment.

In this example, the coolant is described as being used to cool portions of the battery pack 12. In other examples, the coolant could instead be used to heat portions of the battery pack 12.

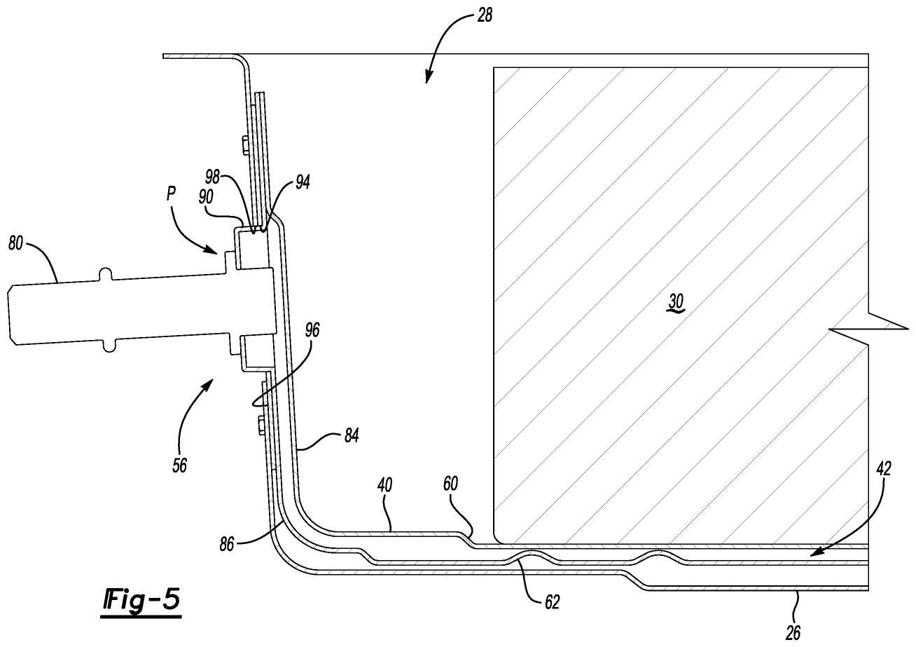

The inlet conduit 50 and the outlet conduit 52 can be coolant hoses. The inlet conduit 50 and the outlet conduit 52 are fluidly coupled to the battery pack 12 at a connection interface 56. FIG. 2 shows the inlet conduit 50 and the outlet conduit 52 coupled to the connection interface 56. FIGS. 4 and 5 show the connection interface 56 without the inlet conduit 50 and the outlet conduit 52 being connected.

Notably, the inlet conduit 50 and the outlet conduit 52 can be selectively fluidly coupled to the battery pack 12 at a position P outside the battery pack enclosure 34. That is, the inlet conduit 50 and the outlet conduit 52 can be selectively fluidly coupled to the battery pack 12 without requiring access to the interior area 28 of the battery pack 12.

The inlet conduit 50 and the outlet conduit 52 can, in some examples, connect to the connection interface 56 via quick-connect style connections, which fluidly coupled the inlet conduit 50 and outlet conduit 52 to the battery pack 12. The ability to quickly couple and decouple the inlet conduit 50 and the outlet conduit 52 can, among other things, facilitate servicing the battery pack 12 and its associated assemblies.

The thermal exchange plate assembly 40 includes a first plate 60 and a second plate 62. The first plate 60 is secured adjacent to the second plate 62 to provide the coolant passage 42 therebetween.

An inlet connector 80 and an outlet connector 82 are fluidly coupled to the at least one coolant passage 42. The inlet connector 80 can be connected and disconnected from the inlet conduit 50 at the position P outside the battery pack 12. The outlet connector 82 can be connected and disconnected from the outlet conduit 52 at the position P outside the battery pack 12.

In this example, the inlet connector 80 and the outlet connector 82 are quick-connect fittings. Typically non-threaded and manipulated by hand, quick-connect fittings can be connected and disconnected without severing welds or requiring tools like wrenches.

The first plate 60 includes an upturned flange 84. The second plate 62 also includes an upturned flange 86. The at least one coolant passage 42 extends upwards to the connection interface 56—more particularly to the inlet connector 80 and the outlet connector 82—between the upturned flange 84 and the upturned flange 86.

The inlet connector 80 and the outlet connector 82 can be adhesively secured to the thermal exchange plate assembly 40, for example. This fluidly couples the inlet connector 80 and the outlet connector 82 to the coolant passage 42 provided between the first plate 60 and the second plate 62. In this example, the inlet connector and the outlet connector 82 are directly secured to the upturned flange 86 of the second plate 62. Notably, in the exemplary embodiment, the inlet connector 80 and the outlet connector 82 are connected to the thermal exchange plate assembly 40 without sandwiching the inlet connector 80 and the outlet connector 82 between the first plate 60 and the second plate 62.

To provide clearance for connecting the inlet connector 80 and the outlet connector 82 to the second plate 62, the second plate 62 is formed to include a bumped-out area 90 and a bumped-out area 92.

The inlet connector 80 is secured directly to the bumped-out area 90. The outlet connector 82 is secured to the bumped-out area 92. In other examples, the inlet connector 80 and the outlet connector 82 could be secured to a single bumped-out area.

The bumped-out area 90 and the bumped-out area 92 could be formed with a stamping process. In another example, the thermal exchange plate assembly 40 is roll bonded, and the bumped-out areas 90 and 92 along with other portions of the at least one coolant passage 42 are formed by inflation after the roll bonding.

The bumped-out areas 90 and 92, in this example, projects outward from the battery pack enclosure 22 and protrude through an enclosure opening 94 within a wall of the enclosure tray 26. The upturned flanges 84 and 86 can be secured to the wall of the enclosure tray 26 using mechanical fasteners, for example, to hold the bumped-out areas 90 and 92 within the enclosure opening 94. The mechanical fasteners can extend through the wall of the enclosure tray 26 to engage both the upturned flange 84 of the first plate 60 and the upturned flange 86 of the second plate 62. A seal 96 can be sandwiched between the upturned flange 86 and the wall of the enclosure tray 26 to seal areas about the enclosure opening 94.

The bumped-out area 90 includes an inlet plate opening 98 that receives the inlet connector 80. In this example, the second plate 62 provides an entire circumferential periphery of the inlet plate opening 98. The first plate 60 provides no portion of the inlet plate opening 98.

The inlet connector 80 extends through the enclosure opening 94 and the inlet plate opening 98 in this example. In another example, the inlet connector 80 does not extend through the enclosure opening 94, or does not extend through both the inlet plate opening 98 and the enclosure opening 94.

The bumped-out area 92 includes an outlet plate opening that receives the outlet connector 82. In this example, the second plate 62 provides an entire circumferential periphery of the outlet plate opening. The first plate 60 provides no portion of the outlet plate opening.

The outlet connector 82 extends through the enclosure opening 94 and the outlet plate opening in this example. In another example, the outlet connector 82 does not extend through the enclosure opening 94, or does not extend through both the outlet plate opening and the enclosure opening 94.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly, comprising:
a first plate secured adjacent to a second plate within an interior area of a traction battery pack enclosure to provide at least one coolant passage that extends through an interior area of a battery pack enclosure, the at least one coolant passage between the first plate and the second plate; and
a connector fluidly coupled to the at least one coolant passage, the connector removably connectable with a conduit at a position outside the battery pack enclosure.

2. The assembly of claim 1, wherein the connector is a quick-connect connector.

3. The assembly of claim 1, wherein the connector is adhesively secured directly to the second plate.

4. The assembly of claim 1, wherein the connector extends through an opening in the battery pack enclosure.

5. The assembly of claim 1, wherein the connector extends through a plate opening of the second plate.

6. The assembly of claim 5, wherein the second plate provides an entire circumferential periphery of the plate opening.

7. The assembly of claim 5, wherein the first plate provides no portion of the plate opening.

8. The assembly of claim 1, wherein the connector is secured directly to a bumped-out area of the second plate, the bumped-out area extending through an opening in the battery pack enclosure.

9. The assembly of claim 8, wherein the opening is provided within a wall of an enclosure tray, the bumped-out area extending from inside the battery pack enclosure though the opening to a position outside the battery pack enclosure.

10. The assembly of claim 9, wherein the connector is a first connector, and further comprising a second connector, the first connector providing a coolant inlet to the at least one coolant passage, the second connector providing a coolant outlet from the at least one coolant passage.

11. The assembly of claim 1, wherein no portion of the connector is sandwiched between both the first plate and the second plate.

12. The assembly of claim 1, wherein the first plate and the second plate each include an upturned flange, the connector secured directly to the upturned flange of the second plate to fluidly couple the connector to the at least one coolant passage.

13. The assembly of claim 12, further comprising a seal sandwiched by the upturned flange of the second plate and the battery pack enclosure.

14. The assembly of claim 12, further comprising a plurality of mechanical fasteners extending through the battery pack enclosure to engage the first plate and the second plate.

15. The assembly of claim 1, wherein the connector is secured directly to a bumped-out area of the second plate.

16. The assembly of claim 10, wherein the at least one coolant passage comprises a serpentine coolant passage configured to communicate a thermal exchange fluid.

17. A battery assembly, comprising:
a plurality of battery cells;
an enclosure assembly that houses said plurality of battery cells;
a thermal exchange plate assembly in thermal communication with the plurality of battery cells, wherein a bumped-out area of the thermal exchange plate assembly protrudes through the enclosure assembly; and
a connector disposed on the bumped-out area.

18. The battery assembly of claim 17, wherein the connector is a quick-connect.

19. The battery assembly of claim 17, wherein said thermal exchange plate assembly is part of a thermal management system of a traction battery pack.
